(19) United States
(12) Patent Application Publication
(10) Pub. No.: US 2003/0104185 A1
(43) Pub. Date: Jun. 5, 2003

(54) Method for producing a multi-functional, multi-ply layer on a transparent plastic substrate and a multi-functional multi-ply layer produced according to said method

(76) Inventors: Karl-Heinz Dittrich, Chemnitz (DE); Dietmar Roth, Oberlungwitz (DE)

Correspondence Address: JORDAN AND HAMBURG LLP, 122 EAST 42ND STREET, SUITE 4000, NEW YORK, NY, 10168, US

(21) Appl. No.: 10/312,606

(22) PCT Filed: Jun. 26, 2001
(86) PCT No.: PCT/DE01/02380

(51) Int. Cl. B32B 15/00

(52) U.S. Cl. 428/209

(57) ABSTRACT

The invention relates to a process for producing a multifunctional multi-ply layer on a transparent plastic substrate and to a multifunctional multi-ply layer produced thereby.

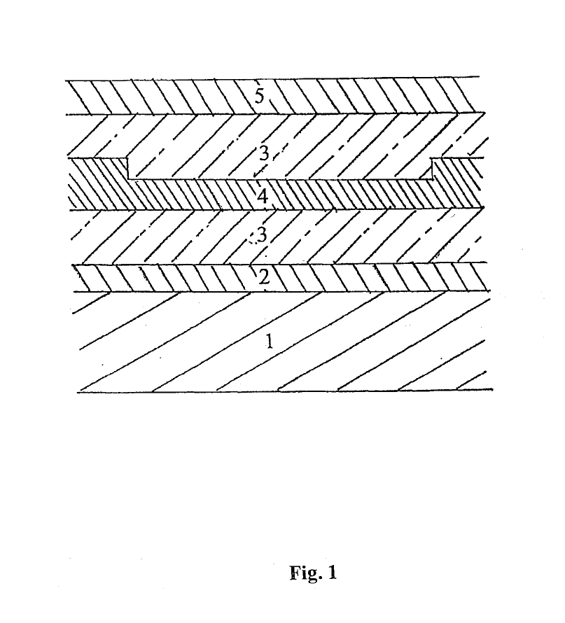

In the process, a multi-ply layer is constructed by a plasma-assisted method on a transparent plastics substrate (1) in an enclosed process by using a microwave plasma source to produce a plasma and continuously maintaining the plasma during the course of the process. A first adhesion-promoting organosilicon polymer layer (2) is subsequently deposited in the microwave plasma, and then cathode sputtering is used to deposit a first ITO layer (3), and a transparent layer of metal and/or of metal oxide and a second ITO layer (3). Finally, an organosilicon polymer layer (5) is deposited.

The multifunctional multi-ply layer is composed of a first adhesion-promoting organosilicon polymer layer (2) with a thickness of from 50 to 300 nm, of a first ITO layer (3) with a thickness of from 50 from 300 nm, of at least one transparent layer with a thickness of from 10 to 30 nm of metal and/or of metal oxide, of a second ITO layer (3) with a thickness of from 50 to 300 nm, and of at least one final organosilicon polymer layer (5) with a thickness of from 300 nm to 6 000 nm.

### TECHNICAL FIELD

The invention relates to a process for producing a multifunctional multi-ply layer on a transparent plastics substrate, the layer being optically transparent, electrically conductive and scratch-resistant.

The invention further relates to multifunctional multi-ply layer produced by the process. Multi-ply layers of this type are in particular suitable for application in heatable plastics glazing for vehicles, visors, and the like.

### PRIOR ART

A wide variety of functional layer systems is known from the prior art, these being applied to metal substrates, ceramic substrates or plastics substrates. To produce layer systems of this type there are also, for example, a number of various known plasma-assisted processes. A fundamental distinction may be made here between the processes which require substrate temperatures above 300° C., e.g. for metal substrates or ceramic substrates, and the processes where a substrate whose temperature has to be restricted to 120° C. or below, e.g. for plastics substrates.

DE 19733053 A1 gives information about a transparent, low-resistance coating on a transparent substrate. An example of the use of this layer is to apply an optical layer to displays (monitors), i.e. on a glass substrate, the transmittance of the layer being above 80% for wavelengths between 400 and 600 nm. For this, an oxide layer, a transparent metal layer, a second oxide layer, and another transparent metal layer thereupon, and again an oxide layer, are constructed directly on the substrate. The oxide layer described comprises an ITO layer (indium-tin-oxide layer), and the metal layer described comprises a silver layer, which may have copper content.

DE 19634334 C1 discloses information on a wipe- and scratch-resistant reflective coating for optical reflectors. The layer structure is composed of a layer combination made from a first hard layer of thickness at least 1-2 μm of lacquer or polymer, an optically opaque metal layer of thickness 40-100 nm, and a final hard, optically transparent hexamethyldisiloxane (HMDS) protective layer deposited by a plasma-assisted method and having a thickness of 30-100 nm.

The known plasma-assisted processes operating at substrate temperatures below 120° C. can only produce layers with very restricted functional properties. In particular, the prior art does not permit the production of electrically conductive, transparent and scratch-resistant layers or multifunctional multi-ply layers. The cause is substantially that supply of energy to the conductive layer deposited by a plasma-assisted method cannot be permitted to heat the substrate above 120° C. and is therefore insufficient to deposit a layer which has sufficient thickness and therefore has good conductivity and scratch resistance.

### DESCRIPTION OF THE INVENTION

It is an object of the invention, therefore, to provide a process for producing a multifunctional multi-ply layer on transparent plastics, the layer being electrically conductive, transparent and scratch-resistant. Another object is to provide a multifunctional multi-ply process on a transparent plastics substrate, the layer being optically transparent, electrically conductive and scratch-resistant.

The invention achieves the process-related object by way of the characterizing features of Claim 1. The object related to the multifunctional multi-ply layer is achieved by way of the features of Claim 3. Embodiments are characterized in the respective subclaims.

The essence of the invention is the process of the invention, which can produce a multifunctional multi-ply layer on a transparent plastics substrate.

According to the invention, an intensive plasma is produced in the coating chamber by means of a microwave plasma source during the entire process. The organosilicon polymer layers defined in Claim 1 are deposited using the action of this plasma. Cathode sputtering is used to produce the defined transparent layers of metal and/or of metal oxide while the microwave plasma is still present. A significant feature here is that the supply of energy via the microwave plasma source and the cathode sputtering is restricted so that the thermal stress does not damage the plastics substrate. This means that the substrate temperature has to be held below 120° C. for industrially available plastics. The details of the process comprise using a plasma-assisted method to construct the multi-ply layer in an enclosed process. To construct the multi-ply layer, first a monomer, preferably an organosilicon compound, is introduced into the coating space, and oxygen is introduced into the coating space, and a first adhesion-promoting organosilicon polymer layer is deposited. Then, while the microwave plasma is still present, cathode sputtering is used to construct, in succession, a first ITO layer (indium-tin-oxide layer) and then at least one transparent layer of metal and/or of metal oxide and a second ITO layer, in each case with concomitant action of a gas atmosphere required by the technology in the coating chamber. Finally, an organosilicon polymer layer is deposited in the manner used for the first adhesion-promoting organosilicon polymer layer. As mentioned above, the supply of energy via the microwave plasma source and the cathode sputtering is restricted during the entire process in such a way that the thermal stress does not damage the plastics substrate.

The inventive term “enclosed process” is to be interpreted here as meaning that the substrate never comes into contact with the atmosphere during the course of the process. It is insignificant here whether the process is carried out in a batch system or in a continuous system.

According to Claim 2, it is also possible, after the deposition of the transparent layer of metal and/or of metal oxide, to superimpose upon the substrate a mask which does not protectively cover particular regions. In these regions, in an additional step of the process, another identical transparent layer of metal and/or of metal oxide is constructed with a thickness such that these regions can serve as electrically contactable electrodes during industrial utilization of the multi-ply layer. It is also possible here for a specific contact material, e.g. gold, to be deposited onto these particular regions.

The microwave plasma source used in practice is advantageously a high-power ECR (electron cyclotron resonance) microwave plasma source. For the cathode sputtering, use may be made of any desired magnetron cathode sputtering device. For each metal component or metal oxide component, a particular cathode sputtering device is required here.

The process of the invention can construct a multifunctional multi-ply layer on a transparent plastics substrate, the layer being optically transparent, electrically conductive and scratch-resistant. According to Claim 3, the multifuctional multi-ply layer is composed of a first adhesion-promoting organosilicon polymer layer with a thickness of from 50 to 300 nm, of a first ITO layer with a thickness of from 50 to 300 nm, of at least one transparent layer with a thickness of from 10 to 30 nm of metal and/or of metal oxide, of a second ITO layer with a thickness of from 50 to 300 nm, and of at least one final organosilicon polymer layer with a thickness of from 300 nm to 6 000 nm. The thickness ranges given are a result of the industrial technology used, in particular the intended use of the coated plastics substrates. The relatively large range for the final organosilicon polymer layer results from the very varied requirements arising in industry. In instances where the coated plastics substrate receives a particular further treatment, e.g. application of another hard organosilicon lacquer layer, even a thickness in the lower region starting at 300 nm is sufficient. In instances where this layer in itself has to have relatively high scratch resistance, layer thicknesses in the upper region up to 6 000 nm are required.

According to Claim 4, the transparent layer of metal or of metal oxide can have particular regions whose thickness is greater than that of the other regions. The nature of these regions is then such that they can be utilized as electrically contactable electrodes.

Surprisingly, these multifunctional multi-ply layers deposited by means of the process of the invention onto heat-sensitive plastics substrates are optically transparent, electrically conductive and scratch-resistant.

The total functionality of the multi-ply layer is based on the fields of thermal functions (heating by way of ohmic resistance, protection from radiation, etc.), electrical functions (screening-out of electrical fields, prevention of electrical charging, etc.), optical functions (transmission or reflection, antireflective action, etc.) and mechanical functions (protection of the plastic from mechanical attack, barrier action with respect to permeation, etc.).

The coated transparent plastics of the invention also fulfil specifically high requirements arising from automotive construction, e.g. for heatable panes for motor vehicles or heatable visors for helmets.

An example will be used below for further illustration of the invention. The drawing gives a diagram of the structure of an example of a multifunctional multi-ply layer of the invention.

An optically transparent, electrically conductive and scratch-resistant multi-ply layer is to be applied to a transparent plastics substrate 1 which is a curved, injection-moulded, optically transparent polycarbonate sheet with dimensions 20 cm×20 cm.

The coating process uses a coating chamber which has, besides other necessary technological equipment, at least one substrate holder, a high-power ECR microwave plasma source and two magnetron cathode sputtering devices. One magnetron has an ITO target and there is a silver target on the other magnetron.

The transparent plastics substrate 1 was pre-cleaned using isopropyl alcohol and introduced into the coating chamber. The plastics substrate 1 here is positioned to stand vertically on the rotatable substrate holder, the location of which is immediately to the front of the magnetrons.

A pump system is used to evacuate the coating chamber as far as the high-vacuum region. Once the high vacuum has been achieved, argon is allowed to enter the-coating chamber until the chamber pressure is about 0.2 Pa. The microwave plasma source is then trigured. The resultant argon plasma activates the surface of the plastics substrate 1 for about 10 min. As the first subsequent inventive step of the process, a plasma polymer layer is produced as adhesion-promoter layer 2, composed of the elements silicon, carbon and oxygen. To supply the elements, hexamethyldisiloxane (HMDSO) is fed into the coating chamber as monomer for the polymerization.

The vapour pressure of the material is used to introduce a gas stream of about 20 sccm of HMDSO into the coating chamber. Up to 20 sccm of oxygen is also introduced to the process by way of a mass flow regulator during part of the following plasma polymerization process lasting about 10 min. The result is partial conversion of the resultant polymer into SiOₓ.

While the ECR plasma remains active, the gas stream of HMDSO and oxygen is terminated, and a magnetron with an ITO (indium-tin-oxide) target is then switched into the, still active, argon plasma from the ECR source. The plastics substrate 1 on the rotatable substrate holder is positioned at a distance from about 25 cm in front of the sources in such a way that the curved surface which has previously been plasma-activated and polymer-coated is uniformly covered with an ITO layer 3. The thickness of the ITO layer 3 in the example is about 200 nm. In accordance with the invention, the ECR plasma supplies ancillary energy during the cathode sputtering.

The second magnetron is then used to deposit a silver layer 4 on the ITO layer 3. The plastics substrate 1 which has previously been plasma-activated, polymer-treated and coated with an ITO layer in the coating chamber, is moved in a controlled manner past the magnetron with the silver target at a distance of about 25 cm and is uniformly covered with a silver layer 4 with a thickness of about 15 nm. The ECR plasma source assists by providing the silver deposition process with sufficient plasma energy to generate a densely-networked silver structure. The magnetron with the ITO target is in deactivated mode during this step of the process.

In the example, Claim 2 is then applied, in that part of the silver layer 4 constructed is protectively covered by a mask. In the regions not protectively covered, the silver layer 4 is expanded until the total thickness of the silver layer 4 in these regions is about 400 nm. When the plastics substrate 1 is used, the thickened regions can be advantageously used as contact electrodes.

Another ITO layer 3 of thickness about 200 nm, like the first ITO layer 3, is then applied to the silver layer 4 with its local variations in thickness. This embeds and protects the silver layer 4 between the two ITO layers 3.

To protect the resultant composite plastics substrate/ITO/silver/ITO and to prepare for the application of other layers required by technology, the ECR plasma source is finally used to apply a final outer layer 5, the uppermost layers of which have SiOₓ structure. Particular processing steps can then be used to apply other layers, in particular protective layers, e.g. for increased protection of the multifunctional multi-ply layer from mechanical loads, such as scratches, etc.

The polycarbonate plastics substrate 1 coated in this way with the inventive coating as functional layer is exceptionally hard, has good uniform optical transparency and can withstand high electrical stresses. For example, when a direct voltage of 12 V is applied to the regions which have the nature of electrodes and appropriate electrical power is introduced, the plastic substrate 1 can be heated from room temperature to about 60° C., while the polycarbonate substrate and the coating remain sufficiently transparent to permit passage of at least 70% of light in the visible region.

The invention is not limited to the process steps and layers set out in the Description. For example, the invention also includes technical modifications of the selection of the layers of metal and/or of metal oxide, or of the thickness parameters. The invention may in particular be adapted to specific quality requirements.

1. Process for producing a multi-ply layer on a transparent plastics substrate (1), the layer being optically transparent, electrically conductive and scratch-resistant, characterized in that the multi-ply layer is constructed by a plasma-assisted method and in a coating chamber by an enclosed process in which a plasma is produced by means of a microwave plasma source and is continuously maintained during the course of the process, and that a monomer, preferably an organosilicon compound, and oxygen are subsequently introduced into the coating chamber and a first adhesion-promoting organosilicon polymer layer (2) is deposited, and then cathode sputtering is used to construct a first ITO layer (indium-tin-oxide layer) (3), and a transparent layer of metal and/or of metal oxide and a second ITO layer (3), and that finally an organosilicon polymer layer (5) is deposited in the manner used for the first adhesion-promoting organosilicon polymer layer (2), where the supply of energy via the microwave plasma source and the cathode sputtering is restricted so that the thermal stress does not damage the plastics substrate.

2. Process according to claim 1, characterized in that after deposition of the transparent layer of metal and/or of metal oxide onto the plastics substrate (1) a mask is superimposed which does not protectively cover particular regions, and that in these regions another transparent layer of metal and/or of metal oxide is constructed in an additional step of the process with a thickness such that these regions can be utilized as electrically contactable electrodes, and that the mask is removed and the other layers are constructed.

3. Multifunctional multi-ply layer on a transparent plastics substrate (1), the layer being optically transparent, electrically conductive and scratch-resistant, and composed of a first adhesion-promoting organosilicon polymer layer (2) with a thickness of from 50 to 300 nm, of a first ITO layer (3) with a thickness of from 50 to 300 nm, of at least one transparent layer with a thickness of from 10 to 30 nm of metal and/or of metal oxide, of a second ITO layer (3) with a thickness of from 50 to 300 nm, and of at least one final organosilicon polymer layer (5) with a thickness of from 300 nm to 6 000 nm.

4. Multi-ply layer according to claim 3, characterized in that the transparent layer of metal or of metal oxide has particular regions whose thickness is greater than that of the other regions, so that these regions can be utilized as electrically contactable electrodes.
